(19) United States
(12) Patent Application Publication
(10) Pub. No.: US 2018/0055030 A1
(43) Pub. Date: Mar. 1, 2018

(54) BOBBER AND FISHING LINE

(71) Applicant: John Bell, Phoenixville, PA (US)

(72) Inventor: John Bell, Phoenixville, PA (US)

(21) Appl. No.: 15/252,215

(22) Filed: Aug. 31, 2016

(51) Int. Cl. A01K 97/12; A01K 97/00

(52) U.S. Cl. CPC A01K 97/12; A01K 97/00

(57) ABSTRACT

The bobber and fishing line is a bottle shaped bobber with a plastic tube extending through the cap, and extending down through the bottle and exiting through a hole in the bottom end of the bottle shaped bobber, with fishing line running through the length of the tube and out the bottom to a length determined by the user to attach a hook and bait. A clip on the cap allows for a second bait hook to be attached on the top end of the bobber.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of fishing bobbers and more specifically relates to a bottle shaped fishing bobber.

2. Description of the Related Art

A bobber is an item of angling equipment that is attached to the fishing line which serves several purposes. Firstly, it can suspend the bait at a predetermined depth; secondly, due to its buoyancy, it can carry the baited hook to otherwise inaccessible areas of water by allowing the float to drift in the prevailing current; and thirdly, a float also serves as a visual bite indicator.

Bobbers come in different sizes and shapes, and can be made from various materials, such as balsa wood, cork, and plastic. The float is used to enable the angler to cast out a bait away from the shore or boat while maintaining a reference point to where the bait is. The angler will select an appropriate float after taking into account the strength of the current, the wind speed, the size of the bait he or she is using, the depth the angler wishes to present that bait at and the distance the bait is to be cast. Usually, the line between the float and hook will have small weights attached, ensuring that the float sits vertically in the water with only a small brightly colored tip remaining visible. The rest of the float is usually finished in a dull neutral color to render it as inconspicuous as possible to the fish. Each float style is designed to be used in certain types of conditions such as slow or fast rivers, windy or still water or small confined waters such as canals.

On many occasions, the distance between the fishing bait and the bobber, set by the angler, gets shortened, or alternately, lengthened by the bobber sliding on the fishing line; which removes the bait from the determined depth.

Various attempts have been made to solve the above-mentioned problems such as those found in U.S. Pat. No. 6,796,076 to Brian J. Bennett; U.S. Design Patent No. D414238 to Dennis Kupperman; and U.S. Publication No. 20060283074 to Tom Barrow. This art is representative of fishing bobbers. None of the above inventions and patents, taken either singly or in combination, is seen to describe the invention as claimed.

Ideally, a fishing bobber should provide ease of use, and have a highly visible finish and, yet would operate reliably and be manufactured at a modest expense. Thus, a need exists for a reliable bobber and fishing line to avoid the above-mentioned problems.

### BRIEF SUMMARY OF THE INVENTION

In view of the foregoing disadvantages inherent in the known fishing bobber art, the present invention provides a novel bobber and fishing line. The general purpose of the present invention, which will be described subsequently in greater detail is to provide a bottle shaped fishing bobber for use attaching bait at a predetermined distance from the bobber below the water line.

A bobber and fishing line for use in fishing comprising a bottle including a top portion, a neck portion, and a bottom portion with a hole therethrough. The bottle is adapted to float on a body of water and have a fishing line connected thereto during use. It further has a cap having a hole therethrough which is attached to a top portion of the bottle.

A tube formed from a plastic material is inserted through the hole in the cap, with a proximal end of the tube being connected to the hole in the cap. The tube extends into the interior portion of the bottle, and a distal end of the tube is connected to a hole in the bottom portion of the bottle. A fishing line extends through the tube and is adapted to be connected with the bottle and a hook on the distal end portion of the fishing line.

The bottle includes a material placed within the interior volume and has a specific gravity less than that of water, such as plastic, cork and balsa wood. The bobber and fishing line further comprise a second hook attachable to an exterior surface of the cap, and the connection between the fishing line and bottle includes a spring member connected therebetween.

The present invention holds significant improvements and serves as a bottle shaped fishing bobber. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, bobber and fishing line, constructed and operative according to the teachings of the present invention.

FIG. 1 shows a perspective view illustrating a bobber and fishing line in an in-use condition according to an embodiment of the present invention.

FIG. 2 is a side view illustrating a fixed-type bobber and fishing line according to an embodiment of the present invention of FIG. 1.

FIG. 3 is a side view illustrating a slip-type bobber and fishing line according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a fishing bobber and more particularly to a bottle shaped fishing bobber for use attaching bait at a predetermined distance from the bobber below the water line as used to improve the ability of a user determine the distance bait will be attached to the fishing line below the bottle shaped bobber, and below the water surface.

Generally speaking, the bobber and fishing line is a bottle shaped bobber with a plastic tube extending through the cap, and extending down through the bottle and exiting through a hole in the bottom end of the bottle shaped bobber, with fishing line running through the length of the tube and out the bottom to a length determined by the user to attach a hook and bait.

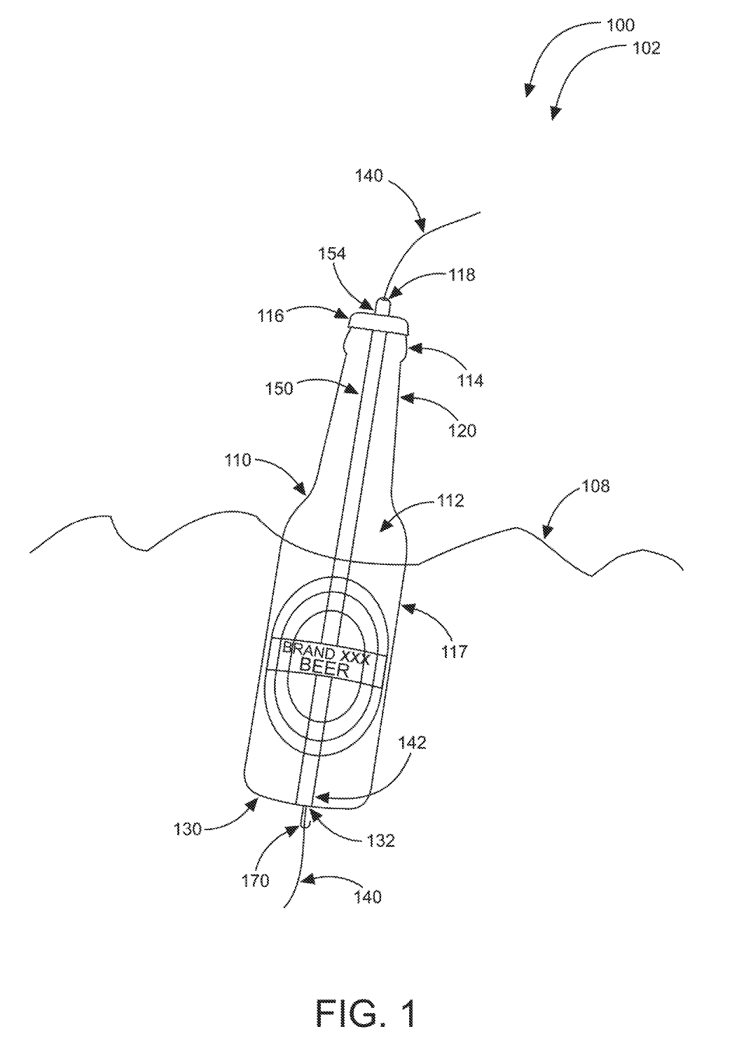

Referring to the drawings by numerals of reference there is shown in FIG. 1, a perspective view illustrating a bobber and fishing line 100 in an in-use condition 102 according to an embodiment of the present invention.

Bobber and fishing line 100 for use in fishing comprising bottle 110 including top portion 114, neck portion 120, and bottom portion 130 with hole 132 therethrough. Bottle 110 is adapted to float on body of water 108 and have fishing line 140 connected thereto during use. It further has cap 116 having hole 118 therethrough which is attached to top portion 114 of bottle 110.

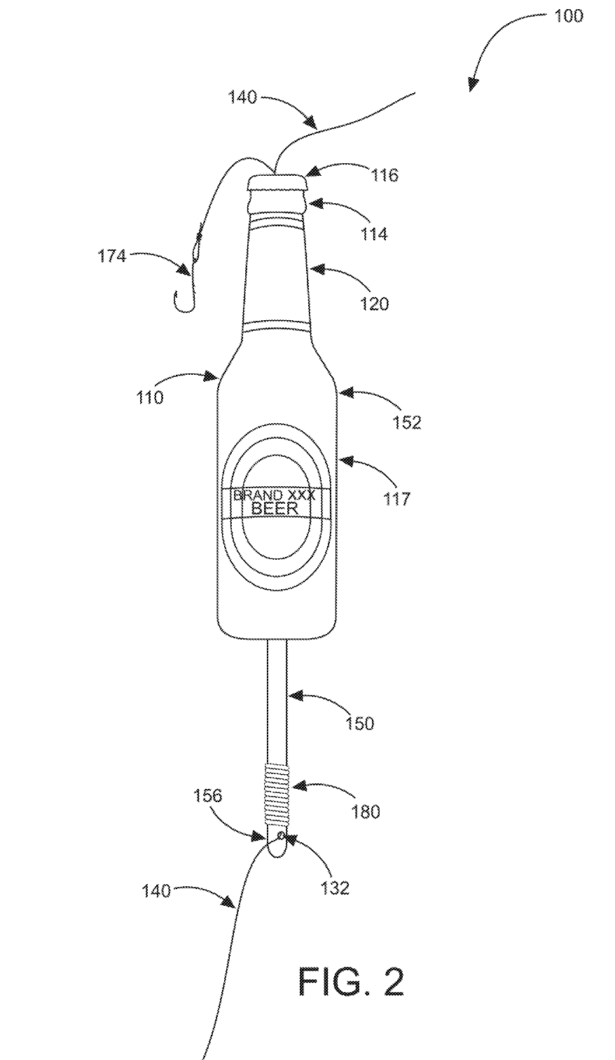

Referring now to FIG. 2, a perspective view illustrating a fixed-type bobber and fishing line 100 according to an embodiment of the present invention.

Tube 150 formed from plastic material 152 is inserted through hole 118 in cap 116, with proximal end 154 of tube 150 being connected to hole 118 in cap 116. Tube 150 extends into interior portion 112 of bottle 110, and distal end 156 of tube 150 is connected to hole 132 in bottom portion 130 of bottle 110. Fishing line 140 extends through tube 150 and is adapted to be connected with bottle 110 and hook 170 on distal end portion 142 of fishing line 140.

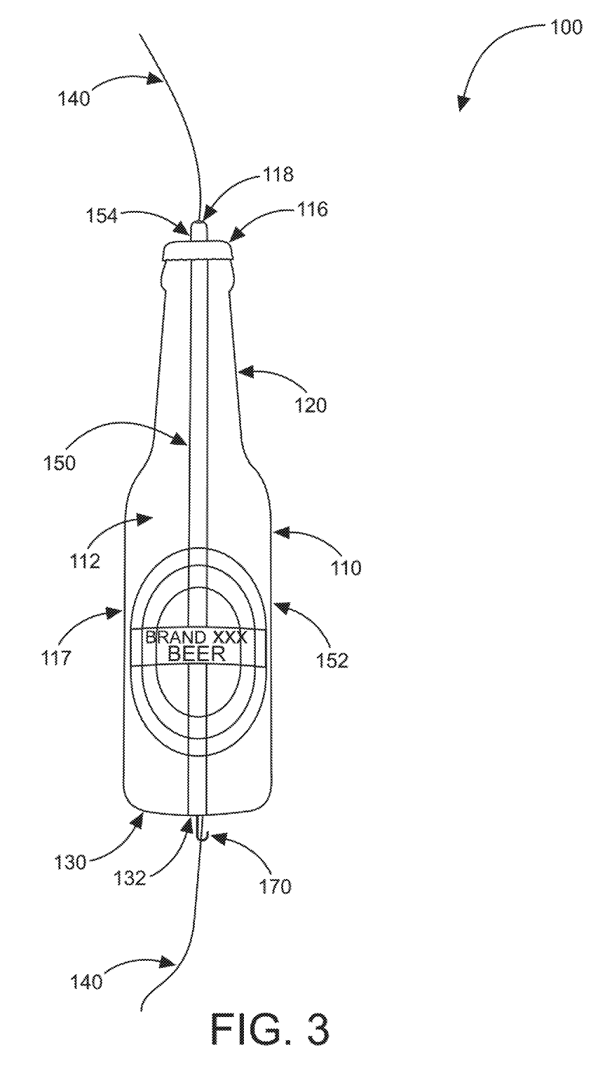

Referring now to FIG. 3, a side view illustrating a slip-type bobber and fishing line 100 according to an embodiment of the present invention.

Bottle 110 includes material placed within interior portion 112 and has a specific gravity less than that of water, such as plastic, cork and balsa wood. Bobber and fishing line 100 further comprise second hook 174 attachable to exterior surface 117 of cap 116, and the connection between fishing line 140 and bottle 110 includes spring member 180 connected therebetween.

Bobber and fishing line 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, for example, including more or less components, customized parts, different color combinations, parts may be sold separately, etc., may be sufficient.

Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A fishing line and bobber for use in fishing comprising:
a bottle including:
a top portion;
a neck portion; and
a bottom portion;
wherein said bottom portion has a hole therethrough; and
wherein said bottle is adapted to float on a body of water and being
adapted to have a fishing line connected thereto during use;
a cap having a hole therethrough;
wherein said cap is removably attached to a top portion of said bottle;
a tube;
wherein said tube is inserted through said hole in said cap;
wherein a proximal end of said tube is connected to said hole in said cap;
wherein said tube extends into an interior portion of said bottle; and
wherein a distal end of said tube is connected to said hole in said bottom portion of said bottle;
a fishing line;
wherein said fishing line extends through said tube and is adapted to be releasably connected with said bottle; and
a hook;
wherein said lower hook is releasably attached to a distal end portion of said fishing line.

2. The fishing line and bobber of claim 1, wherein said bottle further includes a material placed within an interior volume thereof and has a specific gravity less than that of water

3. The fishing line and bobber of claim 2, wherein said material is chosen from a group of materials consisting of plastic, cork and balsa wood.

4. The fishing line and bobber of claim 1, further comprising a second hook releasably attached to an exterior surface of said cap.

5. The fishing line and bobber of claim 1, wherein said connection between said fishing line and said bottle includes a spring member connected therebetween.

6. The fishing line and bobber of claim 1, wherein said tube is formed from a plastic material.
